(19) United States
(12) Patent Application Publication
(10) Pub. No.: US 2025/0074784 A1
(43) Pub. Date: Mar. 6, 2025

(54) Preparation Method of Spindle-shaped W@CuO Material with Adjustable Included Angle

(71) Applicant: Zhengzhou University of Light Industry, Zhengzhou City (CN)

(72) Inventors: Shizhong WEI, Zhengzhou (CN); Feilong GONG, Zhengzhou (CN); Xiran WANG, Zhengzhou (CN); Lu YANG, Zhengzhou (CN); Lihua GONG, Zhengzhou (CN); Xiaodong LI, Zhengzhou (CN); Zhilin CHEN, Zhengzhou (CN)

(21) Appl. No.: 18/619,204

(22) Filed: Mar. 28, 2024

(30) Foreign Application Priority Data
Aug. 30, 2023 (CN) 2023111004537

(51) Int. Cl. C01G 3/02

(52) U.S. Cl. CPC C01G 3/02; C01P 2002/01; C01P 2002/54; C01P 2002/72; C01P 2002/85; C01P 2006/40

(57) ABSTRACT

A preparation method and application of spindle-shaped W@CuO material with adjustable included angle includes the steps of: preparing a copper source solution and adding to a mixture of anionic surfactant and n-butanol; adding a tungsten source solution and dripping an alkali solution, then carrying out hydrothermal reaction, centrifugation, washing and drying. By controlling the growth rate of the high-energy surface at the water-oil interface with the salt concentration, surfactant concentration, supersaturation of water and n-butanol solutions, the monodispersed spindle-shaped structure with unique microstructure and an included angle of 27-74° can be prepared. The surface of W@CuO materials with different included angles shows different electric field strengths, which can effectively modulate the charge transfer during the catalytic process and improve the catalytic reaction activity. The unique spindle-shaped structure makes it have excellent hydrogen evolution performance in alkaline electrolysis of water.

### BACKGROUND OF THE PRESENT INVENTION

### Field of Invention

The present invention belongs to the technology field of transition metal oxide materials, and is related to a controllable preparation technology of transition metal oxide materials, which is in particularly related to a preparation method and application of spindle-shaped W@CuO material with adjustable included angle. The W@CuO refers to W dopped into CuO in the form of W⁵⁺.

### Description of Related Arts

The widespread application of fossil fuels has brought about a global energy crisis and environmental problems. Hydrogen has high energy density and is considered a promising clean energy carrier to replace fossil fuels, which are decreasing in availability day by day. Electrochemical water splitting can continuously produce large amounts of pure hydrogen, but this process requires efficient hydrogen evolution reaction (HER) electrocatalysts to reduce overpotential and make the water splitting process more energy efficient. Water splitting electrolysis technology is based on the principle of electrochemical water splitting, using renewable electricity or solar energy to drive water splitting into hydrogen and oxygen, and is considered to be the most promising and sustainable way to produce hydrogen. However, whether it is electrolysis of water or photolysis of water, highly active and highly stable non-noble metal hydrogen evolution and oxygen evolution catalysts are needed to make the water splitting reaction economical and energy-saving. Noble metals, such as platinum (Pt) and ruthenium (Ru) or iridium (Ir) oxides, are often used as catalysts for water splitting, However, their poor stability, high cost, and scarcity hinder the large-scale application of these noble metal-based oxide electrocatalysts. Therefore, the development of low-cost and durable high-performance water-splitting bifunctional electrocatalysts is an important step towards the practical application of renewable electrochemical energy technologies.

Copper oxide (CuO) is considered to be a good alternative to noble metal-based oxide electrocatalysts because of its inherent characteristics such as high stability, high electrochemical activity, easy preparation of various nanostructures, strong redox ability, and low cost. However, when a single CuO material is used as a catalyst for water splitting to produce green hydrogen, there are still some problems that need to be solved. For example: the desorption energy barrier of hydrogen on the CuO surface is high and the conductivity is poor. It is common that other transition metal oxides are added, various nanostructures are designed, or a small amount of precious metals are loaded to change its catalytic performance. For example, the literature (Langmuir, 2023, 39, 3358-3370) disclosed that the CeO2-CuO nanocomposite material is synthesized by the hydrothermal method. At a current density of 10 mA·cm⁻², the HER overpotential is 245 mV and a Tafel slope is 108.4 mV dec⁻¹, and at a constant potential of −0.6 V (vs RHE), the current decreases by 14.7% after 10 hours of operation. The literature (Nano Energy, 2023,111, 108403) disclosed the use of Ru—CuO electrocatalyst synthesized by thermal treatment. In 1 mol·L⁻¹ KOH electrolyte at a current density of 10 mA·cm⁻², the HER overpotential is 19.8 mV, and the Tafel slope is 27.9 mV·dec⁻¹, after working for 50 hours with an initial operating current density of 10 mA·cm⁻², the current density remains at 8.5 mA·cm⁻², and the current decreases by 15%.

The above methods provide some ideas for the preparation of copper-based electrocatalytic hydrogen production materials, but there are still some problems needed to be solved: (1) Long-term stability under large operating current (100 mA·cm⁻²) is still very challenging. (2) The exploration of the structure-activity relationship between structure and performance still needs to be improved.

### SUMMARY OF THE PRESENT INVENTION

In order to solve the above problems in the existing technology, the present invention provides a preparation method and application of spindle-shaped W@CuO material with adjustable included angle.

The technical solution of the present invention is realized as follows:

A preparation method of spindle-shaped W@CuO material with adjustable included angle comprises the following steps:
(1) adding anionic surfactant to n-butanol, and processing ultrasonication until clear to obtain M1 solution;
(2) adding copper source and tungsten source to deionized water respectively, and processing ultrasonication until clear to obtain M2 solution and M3 solution respectively;
(3) dripping the M2 solution in step (2) to the M1 solution in step (1) to obtain a microemulsion;
(4) stirring and then dripping the microemulsion in step (3) into the M3 solution in step (2), stirring again and dripping an alkali solution, carrying out hydrothermal reaction, centrifugation, washing and drying to obtain a spindle-shaped W@CuO material with adjustable angle.

In the above step (1), the anionic surfactant is sodium bis(2-ethylhexyl)succinate sulfonate, sodium lauryl sulfate or ammonium lauryl sulfate; and a concentration of the anionic surfactant in the M1 solution is 30-100 mmol/L.

In the above step (2), the copper source is any one of copper acetate, copper chloride, copper sulfate and copper nitrate; and a concentration of the copper source in the M2 solution is 0.5-2 mmol/L. In the above step (2), the tungsten source is any one of sodium tungstate, ammonium metatungstate and ammonium paratungstate; and a concentration of the tungsten source in the M3 solution is 0.5-2 mmol/L.

In the above step (3), a molar ratio of the anionic surfactant to the copper source in the microemulsion is (5-66.7): 1.

In the above microemulsion, a volume ratio of M1 solution and M2 solution is 1:3.

In the reaction system in the above step (4), the alkali is any one of sodium hydroxide solution, potassium hydroxide solution and ammonia water; and a molar ratio of the copper source, the tungsten source and the alkali is 1:0.01-0.2:100-400.

In the above hydrothermal reaction, a temperature is 25° C.-180° C., and a reaction time is 2 hours—72 hours.

The spindle-shaped W@CuO material prepared by the above method has an included angle of 27°-74°.

The spindle-shaped W@CuO material has an application in electrolysis of water to produce green hydrogen.

The spindle-shaped W@CuO material has an application in preparing alkaline water electrolysis hydrogen evolution catalyst.

The above spindle-shaped W@CuO material is used as the electrode material. The unique spindle-shaped structure of the material and the introduction of W enable it to have an overpotential of only 95 mV at a current density of 10 mA·cm⁻² in 1 mol·L⁻¹ KOH electrolyte; and after working for 120 hours with an initial operating current density of 20 mA·cm⁻², the current density drops to 17.1 mA·cm⁻², with a retention rate of 85.5%; after working for 50 hours with an initial operating current density of 100 mA·cm⁻², the current density drops to 82.1 mA·cm⁻², with a retention rate of 82.1%.

The present invention has the following advantageous effect:

1. The present invention controls the growth rate of high-energy surfaces at the water-oil interface by controlling the salt concentration, surfactant concentration, and supersaturation of water and n-butanol solutions. (According to the kinetic formula v=k*C^{a}(A)*C^{b}(B), different reactant concentrations and different reaction rates will lead to differences in crystal nucleation and growth; according to the critical micelle concentration expression: CMC=(kT/πa\hat{ }2N_{A})ln (K), the stable form of micelles under different salt concentrations are regulated.), and a controllable synthesis technology of spindle-shaped structure W@CuO materials with adjustable angle (27°-74°) has been created, with the details as follows: When the concentration of sodium bis(2-ethylhexyl)succinate sulfonate in M1 is 36 mmol·L⁻¹, the concentration of copper acetate in M2 is 0.6 mmol·L⁻¹, and the concentration of sodium tungstate in M3 is 0.6 mmol·L⁻¹, then a spindle-shaped W@CuO material with an included angle of 27 degrees can be obtained. Increasing the salt concentration and surfactant concentration can increase the included angle of the spindle-shaped W@CuO material. When the concentration of sodium bis(2-ethylhexyl)succinate sulfonate in M1 is 72 mmol·L⁻¹, the concentration of copper acetate in M2 is 1.2 mmol·L⁻¹, and the concentration of sodium tungstate in M3 is 1.2 mmol·L⁻¹, a spindle-shaped W@CuO material with an included angle of 56 degrees can be obtained. When the concentration of sodium bis(2-ethylhexyl)succinate sulfonate in M1 is 90 mmol·L⁻¹, the concentration of copper acetate in M2 is 1.5 mmol·L⁻¹, and the concentration of sodium tungstate in M3 is 1.5 mmol·L⁻¹, a spindle-shaped W@CuO material with an included angle of 74 degrees can be obtained.

2. By strictly controlling the generation of precursors under reaction conditions, the present invention obtains a spindle-shaped structure W@CuO material with adjustable included angles. The prepared W@CuO composite material is used as a catalyst electrode material, which has an overpotential of only 95 mV at a current density of 10 mA·cm⁻² and the corresponding Tafel slope of 67 mV·dec⁻¹ in a KOH electrolyte of 1 mol·L⁻¹. And after working for 120 hours with an initial operating current density of 20 mA·cm⁻², the current density drops to 17.1 mA·cm⁻², with a retention rate of 85.5%. And after working for 50 hours with an initial operating current density of 100 mA·cm⁻², the current density drops to 82.1 mA·cm⁻², with a retention rate of 82.1%. The spindle-shaped structure W@CuO material with an included angle of 27° is a water electrolysis catalytic material with good performance, which is expected to achieve efficient, long-term and stable water electrolysis and hydrogen evolution performance.

3. The present invention has developed a synthesis technology that can be used to prepare W@CuO composite materials. The material exhibits a unique spindle-shaped structure, and composite materials with different included angles exhibit different catalytic properties. The present invention provides ideas for developing highly active and high-stability electrocatalytic hydrogen evolution materials by regulating the microstructure design of materials.

### BRIEF DESCRIPTION OF THE DRAWINGS

In order to more clearly explain the embodiments of the present invention or the technical solutions in the prior arts, the drawings needed to be used in the description of the embodiments or the prior arts will be briefly introduced below. Obviously, the drawings in the following description are only some embodiments of the present invention. For those of ordinary skill in the art, based on these drawings without exerting creative efforts, other drawings can also be obtained.

FIG. 1 is the X-ray diffraction (XRD) spectrum of the spindle-shaped W@CuO material in Embodiments 1, 5, and 9.

FIG. 2 illustrates images of the field emission scanning electron microscope (FESEM), transmission electron microscope (TEM) and high-resolution TEM of the spindle-shaped W@CuO material with an included angle of 27 degrees.

FIG. 3 illustrates a transmission electron microscopy (TEM) image of the spindle-shaped W@CuO material with an included angle of 36 degrees.

FIG. 4 illustrates a transmission electron microscopy (TEM) image of the spindle-shaped W@CuO material with an included angle of 43 degrees.

FIG. 5 illustrates images of the field emission scanning electron microscope (FESEM), transmission electron microscope (TEM) and high-resolution TEM of the spindle-shaped W@CuO material with an included angle of 56 degrees.

FIG. 6 illustrates a transmission electron microscopy (TEM) image of the spindle-shaped W@CuO material with an included angle of 65 degrees.

FIG. 7 illustrates images of the field emission scanning electron microscope (FESEM), transmission electron microscope (TEM) and high-resolution TEM of the spindle-shaped W@CuO material with an included angle of 74 degrees.

FIG. 8 illustrates an X-ray energy spectroscopy (EDS) of the spindle-shaped W@CuO material with an included angle of 27 degrees.

FIG. 9 illustrates an X-ray energy spectroscopy (EDS) of the spindle-shaped W@CuO material with an included angle of 56 degrees.

FIG. 10 illustrates an X-ray energy spectroscopy (EDS) of the spindle-shaped W@CuO material with an included angle of 74 degrees.

FIG. 11 illustrates an X-ray photoelectron spectroscopy (XPS) of the spindle-shaped W@CuO material with an included angle of 27 degrees.

FIG. 12 illustrates images of finite element simulation analysis based on structural parameters of the spindle-shaped W@CuO material in Embodiments 1, 5, and 9.

FIG. 13 illustrates the LSV curve and Tafel slope diagram of the spindle-shaped W@CuO material in 1 mol·L⁻¹ KOH electrolyte in Embodiments 1, 5, and 9.

FIG. 14 illustrates the chronocurrent curve of the spindle-shaped W@CuO material at a current density of 20 mA·cm⁻² in Embodiment 1.

FIG. 15 illustrates the chronocurrent curve of the spindle-shaped W@CuO material at a current density of 100 mA·cm⁻² in Embodiment 1.

### DETAILED DESCRIPTION OF THE PREFERRED EMBODIMENT

The technical solutions in the embodiments of the present invention will be clearly and completely described below with reference to the accompanying drawings in the embodiments of the present invention. Obviously, the described embodiments are only some of the embodiments of the present invention, rather than all the embodiments. Based on the embodiments of the present invention, all other embodiments obtained by those of ordinary skill in the art without exerting creative efforts fall within the scope of protection of the present invention.

### Embodiment 1

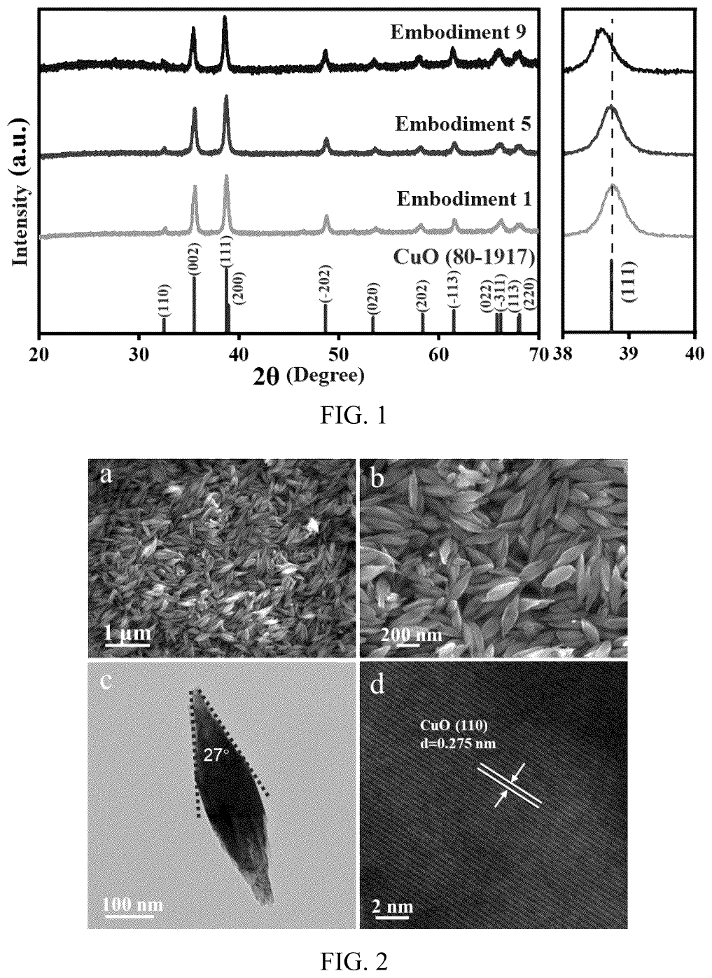

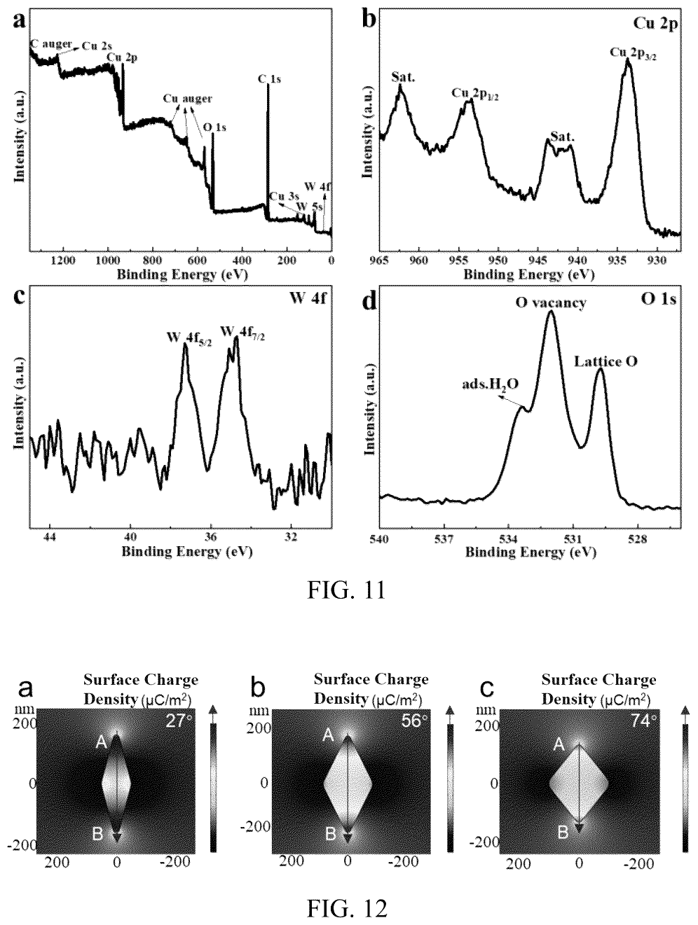

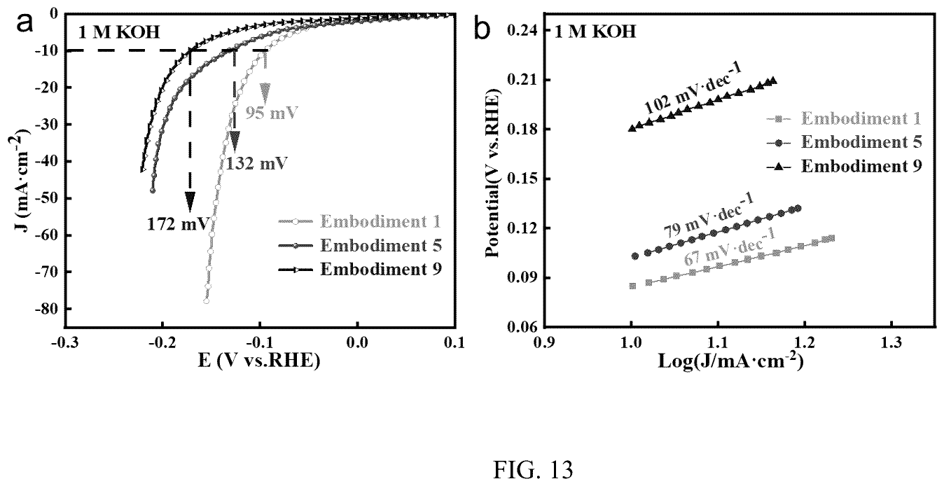

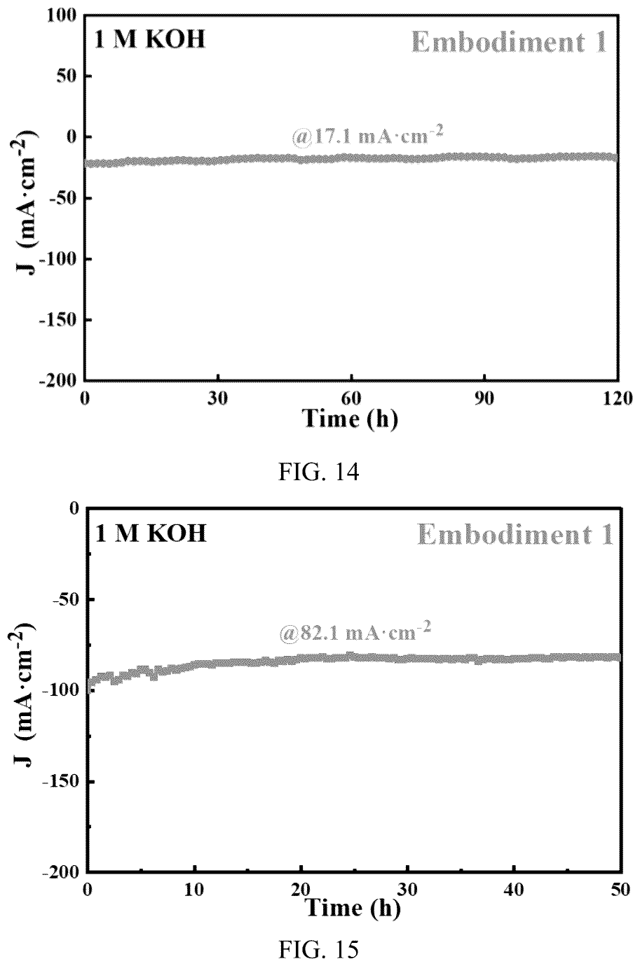

According to this embodiment, a preparation method of spindle-shaped W@CuO material with an included angle of 27 degrees comprises the following steps:
adding 3.6 mmol sodium bis(2-ethylhexyl)succinate sulfonate (1.6004 g) to 100 mL n-butanol, and processing ultrasonication until clear to obtain M1 solution;
adding 0.18 mmol copper acetate (0.0359 g) to 300 mL deionized water, and processing ultrasonication until clear to obtain M2 solution;
adding 0.03 mmol sodium tungstate (0.0099 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material with an included angle of 27 degrees. The XRD spectrum is shown in FIG. 1, the FESEM and TEM images are shown in FIG. 2, the EDS image is shown in FIG. 8, the XPS image is shown in FIG. 11 and the finite element simulation analysis is shown in FIG. 12. According to the production method of the working electrode, the W@CuO material is used as the working electrode for electrochemical testing. The LSV curve and the corresponding Tafel slope in 1 mol·L⁻¹ KOH electrolyte are shown in FIG. 13. The chronocurrent curve at a current density of 20 mA·cm⁻² is shown in FIG. 14. The chronocurrent curve at a current density of 100 mA·cm₋₂ is shown in FIG. 15.

As shown in FIG. 1, the image on the left shows the XRD spectrum of the W@CuO material in which strong diffraction peaks are observed, and their peak positions are all at the position of CuO (PDF #80-1917); while no obvious W diffraction peak is observed. It is speculated that firstly, the content of W is small, and secondly, W exists inside the composite material in the form of lattice doping. The image on the right is a partial enlarged view of the XRD spectrum. It is observed that the diffraction peak of the CuO (111) crystal plane is slightly shifted to a small angle, indicating that W is successfully doped into the CuO crystal lattice.

As shown in FIG. 2, image a and image b are FESEM images of the composite material at different magnifications. It can be seen that the composite material has a uniformly dispersed spindle-shaped structure. Image c is the TEM image of the composite material. It can be seen that it has a monodisperse spindle-shaped structure, and the included angle is about 27 degrees. Image d is a high-resolution TEM image of the composite material, and the lattice stripes on the CuO (110) plane can be clearly observed.

FIG. 8 is the EDS image of the composite material. The peaks of oxygen and copper elements can be clearly observed, and the peak of tungsten element is weaker. The reason is that the content of tungsten element is small and most of them are present inside the composite material in the form of lattice doping. The table illustrates the specific content of the three elements, of which the mass fraction of O is 21.48%, the mass fraction of Cu is 77.61%, and the mass fraction of W is 0.91%.

Referring to FIG. 11, image a illustrates the full spectrum of the spindle-shaped W@CuO material with an included angle of 27 degrees in which the characteristic peaks of Cu 2p, W 4f and O is can be clearly identified, thus proving the successful preparation of W@CuO; image b illustrates the spectrum of Cu 2p in which the peaks at 962.4, 943.7 and 940.9 eV are satellite peaks of Cu 2p, which are consistent with the typical characteristics of Cu²⁺; image c illustrates its W 4f spectrum in which the peaks at 37.3 eV and 34.7 eV are identified as W 4f_{7/2} and W 4f_{5/2} respectively, indicating that the W element exists in the form of W⁵⁺; image d illustrates its O is spectrum in which the peaks at 533.4, 532 and 529.7 eV are identified as adsorbed oxygen, oxygen vacancies and lattice oxygen respectively.

As shown in FIG. 12, a refers to an image of the finite element simulation analysis of the spindle-shaped W@CuO material with an included angle of 27 degrees. It can be observed that at the same voltage, its local electric field is the largest, which is beneficial to promoting charge transfer during the catalytic process and improving catalytic reaction activity.

As shown in FIG. 13, the performance test results show that, in a 1 mol·L⁻¹ KOH electrolyte, the overpotential at a current density of 10 mA·cm⁻² is only 95 mV, and the corresponding Tafel slope is 67 mV·dec⁻¹.

As shown in FIG. 14 and FIG. 15, the stability test results show that after working for 120 hours with an initial operating current density of 20 mA·cm⁻², the current density drops to 17.1 mA·cm⁻², with a retention rate of 85.5%; and after working for 50 hours with an initial operating current density of 100 mA·cm⁻², the current density drops to 82.1 mA·cm⁻², with retention rate of 82.1%, indicating that it has good stability.

Preparation method of working electrode: Take about 10 mg of the calcined sample and put it into a 10 mL centrifuge tube. Add deionized water and absolute ethanol into the centrifuge tube at a ratio of 4:1 to make the sample with a concentration of 2 mg·mL⁻¹. Process ultrasonication of the suspension until it is evenly dispersed. Then, take 250 μL of the evenly dispersed suspension and drop it to the 1×1 cm² nickel foam electrode. After that, evenly disperse 25 μL Nafion aqueous solution on the electrode surface. After drying at 60° C. for 15 minutes, it can be used as a working electrode for electrochemical testing.

Electrochemical tests are performed on an electrochemical workstation (CHI-660E, CHI Instruments, Shanghai, China). The electrolyte is 1 mol·L⁻¹ KOH, the mercury/mercury oxide electrode is used as the reference electrode, and the platinum electrode is used as the counter electrode. The sample is the working electrode. The scanning rate is 5 mV·s⁻¹. The measured potential can be calibrated to the value of the reversible hydrogen electrode (RHE) by the formula: E_{RHE}=E_{SCE}+E⁰_{SCE}+0.059 pH, where E⁰_{SCE}=0.098 V (mercury/mercury oxide) and E_{SCE} represents the actual measured potential.

### Embodiment 2

According to this embodiment, a preparation method of spindle-shaped W@CuO material comprises the following steps:
adding 7.2 mmol sodium bis(2-ethylhexyl)succinate sulfonate (3.2008 g) to 100 mL n-butanol, and processing ultrasonication until clear to obtain M1 solution;
adding 0.18 mmol copper sulfate (0.0449 g) to 300 mL deionized water, and processing ultrasonication until clear to obtain M2 solution;
adding 0.03 mmol sodium tungstate (0.0099 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

### Embodiment 3

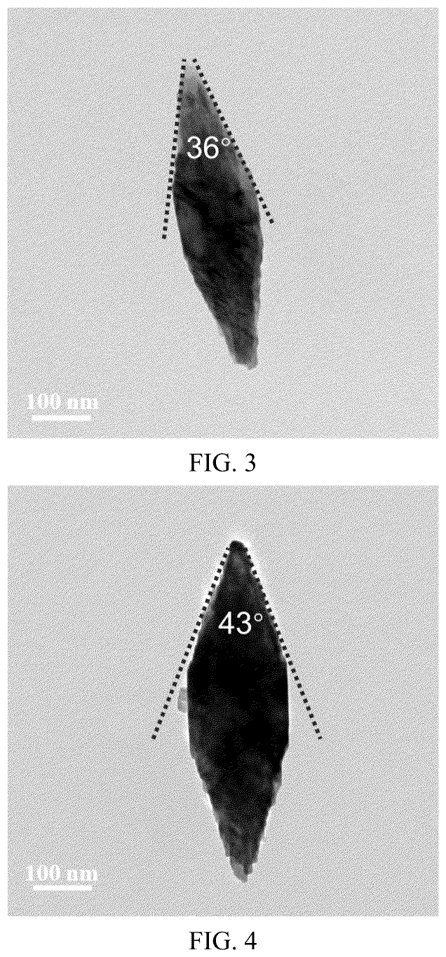

According to this embodiment, a preparation method of spindle-shaped W@CuO material with an included angle of 36 degrees comprises the following steps:
adding 9.0 mmol sodium bis(2-ethylhexyl)succinate sulfonate (4.0010 g) to 100 mL n-butanol, and processing ultrasonication until clear to obtain M1 solution;
adding 0.18 mmol copper chloride (0.0309 g) to 300 mL deionized water, and processing ultrasonication until clear to obtain M2 solution;
adding 0.03 mmol sodium tungstate (0.0099 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material with an included angle of 36 degrees. The TEM image is shown in FIG. 3. It can be observed that it is a monodisperse spindle-shaped structure with an included angle of approximately 36 degrees.

### Embodiment 4

According to this embodiment, a preparation method of spindle-shaped W@CuO material with an included angle of 43 degrees comprises the following steps:
adding 3.6 mmol sodium lauryl sulfate (1.0382 g) to 100 mL n-butanol, and processing ultrasonication until clear to obtain M1 solution;
adding 0.36 mmol copper acetate (0.0718 g) to 300 mL deionized water, and processing ultrasonication until clear to obtain M2 solution;
adding 0.06 mmol sodium tungstate (0.0198 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material with an included angle of 43 degrees. The TEM image is shown in FIG. 4. It can be observed that it is a monodisperse spindle-shaped structure with an included angle of approximately 43 degrees.

### Embodiment 5

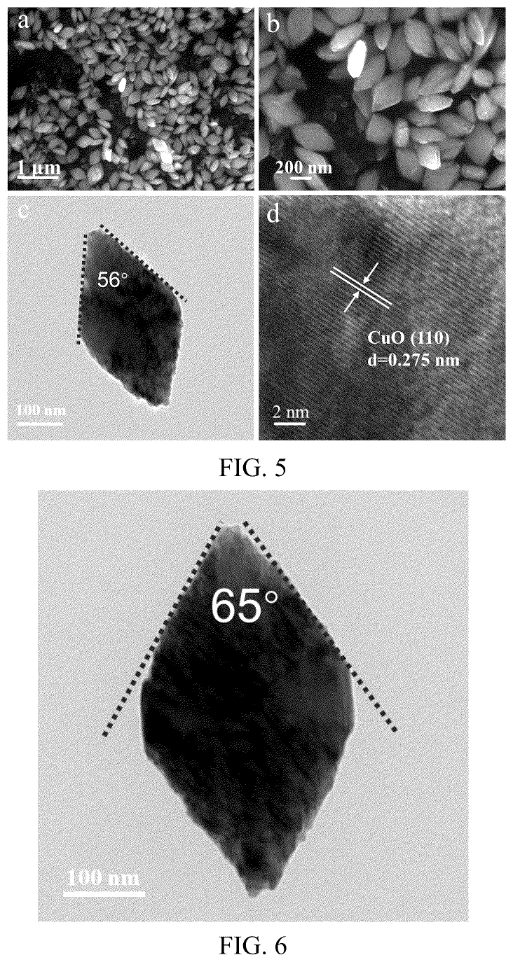

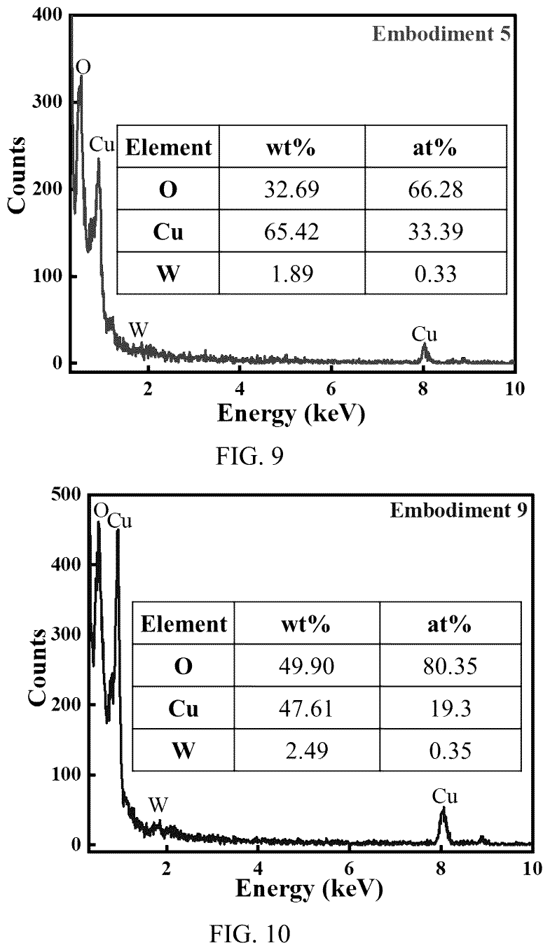

According to this embodiment, a preparation method of spindle-shaped W@CuO material with an included angle of 56 degrees comprises the following steps:
adding 7.2 mmol sodium bis(2-ethylhexyl)succinate sulfonate (3.2008 g) to 100 mL n-butanol, and processing ultrasonication until clear to obtain M1 solution;
adding 0.36 mmol copper acetate (0.0718 g) to 300 mL deionized water, and processing ultrasonication until clear to obtain M2 solution;
adding 0.06 mmol sodium tungstate (0.0198 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material with an included angle of 56 degrees. The XRD spectrum is shown in FIG. 1, the FESEM and TEM images are shown in FIG. 5, the EDS image is shown in FIG. 9, and the finite element simulation analysis is shown in FIG. 12. According to the production method of the working electrode, the W@CuO material is used as the working electrode for electrochemical testing. The LSV curve and the corresponding Tafel slope in 1 mol·L¹ KOH electrolyte are shown in FIG. 13 respectively.

As shown in FIG. 1, the image on the left shows the XRD spectrum of the W@CuO material in which strong diffraction peaks are observed, and their peak positions are all at the position of CuO (PDF #80-1917); while no obvious W diffraction peak is observed. It is speculated that firstly, the content of W is small, and secondly, W exists inside the composite material in the form of lattice doping. The image on the right is a partial enlarged view of the XRD spectrum. It is observed that the diffraction peak of the CuO (111) crystal plane is shifted to a small angle, indicating that W is successfully doped into the CuO crystal lattice.

As shown in FIG. 5, image a and image b are FESEM images of the composite material at different magnifications. It can be seen that the composite material has a uniformly dispersed spindle-shaped structure. Image c is the TEM image of the composite material. It can be seen that it has a monodisperse spindle-shaped structure, and the included angle is about 56 degrees. Image d is a high-resolution TEM image of the composite material, and the lattice stripes on the CuO (110) plane can be clearly observed.

FIG. 9 is the EDS image of the composite material. The peaks of oxygen and copper elements can be clearly observed, and the peak of tungsten element is weaker. The reason is that the content of tungsten element is small and most of them are present inside the composite material in the form of lattice doping. The table illustrates the specific content of the three elements, of which the mass fraction of O is 32.69%, the mass fraction of Cu is 65.42%, and the mass fraction of W is 1.89%.

As shown in FIG. 12, image b refers to an image of the finite element simulation analysis of the spindle-shaped W@CuO material with an included angle of 56 degrees. It can be observed that at the same voltage, its local electric field is smaller than that of the spindle-shaped W@CuO material with an included angle of 27 degrees but larger than that of the spindle-shaped W@CuO material with an included angle of 74 degrees, which is beneficial to promoting charge transfer during the catalytic process and improving catalytic activity.

As shown in FIG. 13, the performance test results show that, in a 1 mol·L⁻¹ KOH electrolyte, the overpotential at a current density of 10 mA·cm⁻² is only 132 mV, and the corresponding Tafel slope is 79 mV·dec⁻¹.

### Embodiment 6

According to this embodiment, a preparation method of spindle-shaped W@CuO material comprises the following steps:
adding 9.0 mmol ammonium lauryl sulfate (2.5509 g) to 100 mL n-butanol, and processing ultrasonication until clear to obtain M1 solution;
adding 0.36 mmol copper nitrate (0.0870 g) to 300 mL deionized water, and processing ultrasonication until clear to obtain M2 solution;
adding 0.06 mmol sodium tungstate (0.0198 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

### Embodiment 7

According to this embodiment, a preparation method of spindle-shaped W@CuO material comprises the following steps:
adding 3.6 mmol sodium bis(2-ethylhexyl)succinate sulfonate (1.6004 g) to 100 mL n-butanol, and processing ultrasonication until clear to obtain M1 solution;
adding 0.45 mmol copper acetate (0.0898 g) to 300 mL deionized water, and processing ultrasonication until clear to obtain M2 solution;
adding 0.0075 mmol ammonium paratungstate (0.0230 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

### Embodiment 8

According to this embodiment, a preparation method of spindle-shaped W@CuO material with an included angle of 65 degrees comprises the following steps:
adding 7.2 mmol sodium bis(2-ethylhexyl)succinate sulfonate (3.2008 g) to 100 mL n-butanol, and processing ultrasonication until clear to obtain M1 solution;
adding 0.45 mmol copper nitrate (0.1087 g) to 300 mL deionized water, and processing ultrasonication until clear to obtain M2 solution;
adding 0.0075 mmol ammonium metatungstate (0.0222 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material with an included angle of 65 degrees. The TEM image is shown in FIG. 6. It can be observed that it is a monodisperse spindle-shaped structure with an included angle of approximately 65 degrees.

### Embodiment 9

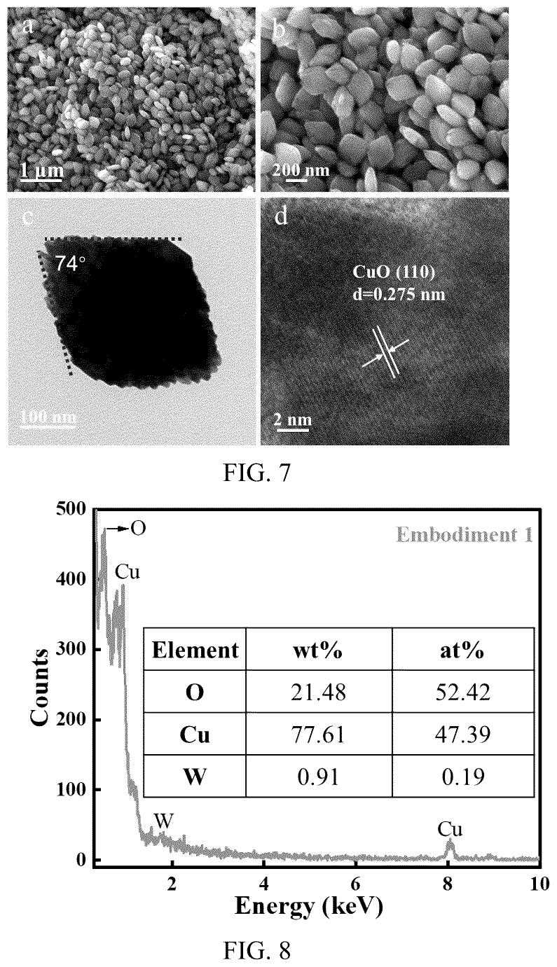

According to this embodiment, a preparation method of spindle-shaped W@CuO material with an included angle of 74 degrees comprises the following steps:
adding 9.0 mmol sodium bis(2-ethylhexyl)succinate sulfonate (4.0010 g) to 100 mL n-butanol, and processing ultrasonication until clear to obtain M1 solution;
adding 0.45 mmol copper acetate (0.0898 g) to 300 mL deionized water, and processing ultrasonication until clear to obtain M2 solution;
adding 0.075 mmol sodium tungstate (0.0247 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material with an included angle of 74 degrees. The XRD spectrum is shown in FIG. 1, the FESEM and TEM images are shown in FIG. 7, the EDS image is shown in FIG. 10, and the finite element simulation analysis is shown in FIG. 12. According to the production method of the working electrode, the W@CuO material is used as the working electrode for electrochemical testing. The LSV curve and the corresponding Tafel slope in 1 mol·L⁻¹ KOH electrolyte are shown in FIG. 13.

As shown in FIG. 1, the image on the left shows the XRD spectrum of the W@CuO material in which strong diffraction peaks are observed, and their peak positions are all at the position of CuO (PDF #80-1917); while no obvious W diffraction peak is observed. It is speculated that firstly, the content of W is small, and secondly, W exists inside the composite material in the form of lattice doping. The image on the right is a partial enlarged view of the XRD spectrum. It is obviously observed that the diffraction peak of the CuO (111) crystal plane is shifted to a small angle, indicating that W is successfully doped into the CuO crystal lattice.

As shown in FIG. 7, image a and image b are FESEM images of the composite material at different magnifications. It can be seen that the composite material has a uniformly dispersed spindle-shaped structure. Image c is the TEM image of the composite material. It can be seen that it has a monodisperse spindle-shaped structure, and the included angle is about 74 degrees. Image d is a high-resolution TEM image of the composite material, and the lattice stripes on the CuO (110) plane can be clearly observed.

FIG. 10 is the EDS image of the composite material. The peaks of oxygen and copper elements can be clearly observed, and the peak of tungsten element is weaker. The reason is that the content of tungsten element is small and most of them are present inside the composite material in the form of lattice doping. The table illustrates the specific content of the three elements, in which the mass fraction of O is 49.90%, the mass fraction of Cu is 47.61%, and the mass fraction of W is 2.49%.

As shown in FIG. 12, image c refers to an image of the finite element simulation analysis of the spindle-shaped W@CuO material with an included angle of 74 degrees. It can be observed that at the same voltage, its local electric field is the smallest.

As shown in FIG. 13, the performance test results show that, in a 1 mol·L⁻¹ KOH electrolyte, the overpotential at a current density of 10 mA·cm⁻² is only 172 mV, and the corresponding Tafel slope is 102 mV·dec¹.

### Embodiment 10

According to this embodiment, a preparation method of spindle-shaped W@CuO material comprises the following steps:
adding 4.5 mmol sodium bis(2-ethylhexyl)succinate sulfonate (2.005 g) to 100 mL n-butanol, and processing ultrasonication until clear to obtain M1 solution;
adding 0.18 mmol copper acetate (0.0359 g) to 300 mL deionized water, and processing ultrasonication until clear to obtain M2 solution;
adding 0.03 mmol sodium tungstate (0.0099 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

### Embodiment 11

According to this embodiment, a preparation method of spindle-shaped W@CuO material comprises the following steps:
adding 3.6 mmol sodium bis(2-ethylhexyl)succinate sulfonate (1.6004 g) to 100 mL n-butanol, and processing ultrasonication until clear to obtain M1 solution;
adding 0.18 mmol copper acetate (0.0359 g) to 300 mL deionized water, and processing ultrasonication until clear to obtain M2 solution;
adding 0.0225 mmol sodium tungstate (0.0074 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

### Embodiment 12

According to this embodiment, a preparation method of spindle-shaped W@CuO material comprises the following steps:
adding 3.6 mmol sodium bis(2-ethylhexyl)succinate sulfonate (1.6004 g) to 100 mL n-butanol, and processing ultrasonication until clear to obtain M1 solution;
adding 0.18 mmol copper chloride (0.0307 g) to 300 mL deionized water, and processing ultrasonication until clear to obtain M2 solution;
adding 0.036 mmol sodium tungstate (0.0119 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

### Embodiment 13

According to this embodiment, a preparation method of spindle-shaped W@CuO material comprises the following steps:
adding 7.2 mmol sodium bis(2-ethylhexyl)succinate sulfonate (3.2008 g) to 100 mL n-butanol, and processing ultrasonication until clear to obtain M1 solution;
adding 0.36 mmol copper acetate (0.0718 g) to 300 mL deionized water, and processing ultrasonication until clear to obtain M2 solution;
adding 0.045 mmol sodium tungstate (0.0148 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 2 hours; then carrying out centrifugation, washing and drying to obtain a spindle-shaped W@CuO material.

### Embodiment 14

According to this embodiment, a preparation method of spindle-shaped W@CuO material comprises the following steps:
adding 7.2 mmol sodium bis(2-ethylhexyl)succinate sulfonate (3.2008 g) to 100 mL n-butanol, and processing ultrasonication until clear to obtain M1 solution;
adding 0.36 mmol copper acetate (0.0718 g) to 300 mL deionized water, and processing ultrasonication until clear to obtain M2 solution;
adding 0.072 mmol sodium tungstate (0.0237 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 60 mmol ammonia water (1 mL) at a rate of one drop per five seconds; stirring for 2 hours and then carrying out hydrothermal reaction at 120° C. for 24 hours; then carrying out centrifugation, washing and drying to obtain a spindle-shaped W@CuO material.

### Embodiment 15

According to this embodiment, a preparation method of spindle-shaped W@CuO material comprises the following steps:
adding 9.0 mmol sodium bis(2-ethylhexyl)succinate sulfonate (4.0010 g) to 100 mL n-butanol, and processing ultrasonication until clear to obtain M1 solution;
adding 0.45 mmol copper acetate (0.0898 g) to 300 mL deionized water, and processing ultrasonication until clear to obtain M2 solution;
adding 0.05625 mmol sodium tungstate (0.0186 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 50 mmol NaOH at a rate of one drop per five seconds; stirring for 2 hours and then carrying out hydrothermal reaction at 120° C. for 12 hours; then carrying out centrifugation, washing and drying to obtain a spindle-shaped W@CuO material.

Method of adding NaOH: Add 0.2000 g NaOH solid to 1 mL deionized water, processing ultrasonication until clear, and add it to the mixed solution at a rate of one drop per five seconds.

### Embodiment 16

According to this embodiment, a preparation method of spindle-shaped W@CuO material comprises the following steps:
adding 9.0 mmol sodium bis(2-ethylhexyl)succinate sulfonate (4.0010 g) to 100 mL n-butanol, and processing ultrasonication until clear to obtain M1 solution;
adding 0.45 mmol copper acetate (0.0898 g) to 300 mL deionized water, and processing ultrasonication until clear to obtain M2 solution;
adding 0.09 mmol sodium tungstate (0.0277 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 50 mmol potassium hydroxide (1 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

Method of adding KOH: Add 0.2806 g KOH solid to 1 mL deionized water, processing ultrasonication until clear, and add it to the mixed solution at a rate of one drop per five seconds.

### Embodiment 17

According to this embodiment, a preparation method of spindle-shaped W@CuO material comprises the following steps:
adding 3.6 mmol sodium bis(2-ethylhexyl)succinate sulfonate (1.6004 g) to 100 mL n-butanol, and processing ultrasonication until clear to obtain M1 solution;
adding 0.18 mmol copper sulfate (0.0449 g) to 300 mL deionized water, and processing ultrasonication until clear to obtain M2 solution;
adding 0.03 mmol sodium tungstate (0.0099 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 48 mmol ammonia water (0.8 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

### Embodiment 18

According to this embodiment, a preparation method of spindle-shaped W@CuO material comprises the following steps:
adding 3.6 mmol sodium bis(2-ethylhexyl)succinate sulfonate (1.6004 g) to 100 mL n-butanol, and processing ultrasonication until clear to obtain M1 solution;
adding 0.18 mmol copper acetate (0.0359 g) to 300 mL deionized water, and processing ultrasonication until clear to obtain M2 solution;
adding 0.03 mmol sodium tungstate (0.0099 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 72 mmol ammonia water (1.2 mL) at a rate of one drop per five seconds; stirring for 2 hours and then carrying out hydrothermal reaction at 120° C. for 12 hours; then carrying out centrifugation, washing and drying to obtain a spindle-shaped W@CuO material.

### Embodiment 19

According to this embodiment, a preparation method of spindle-shaped W@CuO material comprises the following steps:
adding 7.2 mmol sodium bis(2-ethylhexyl)succinate sulfonate (3.2008 g) to 100 mL n-butanol, and processing ultrasonication until clear to obtain M1 solution;
adding 0.36 mmol copper acetate (0.0718 g) to 300 mL deionized water, and processing ultrasonication until clear to obtain M2 solution;
adding 0.03 mmol sodium tungstate (0.0198 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 48 mmol ammonia water (0.8 mL) at a rate of one drop per five seconds; stirring for 2 hours and then carrying out hydrothermal reaction under room temperature for 72 hours; then carrying out centrifugation, washing and drying to obtain a spindle-shaped W@CuO material.

### Embodiment 20

According to this embodiment, a preparation method of spindle-shaped W@CuO material comprises the following steps:
adding 7.2 mmol sodium bis(2-ethylhexyl)succinate sulfonate (3.2008 g) to 100 mL n-butanol, and processing ultrasonication until clear to obtain M1 solution;
adding 0.36 mmol copper acetate (0.0718 g) to 300 mL deionized water, and processing ultrasonication until clear to obtain M2 solution;
adding 0.03 mmol sodium tungstate (0.0198 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 72 mmol ammonia water (1.2 mL) at a rate of one drop per five seconds; stirring for 2 hours and then carrying out hydrothermal reaction at 180° C. for 2 hours; then carrying out centrifugation, washing and drying to obtain a spindle-shaped W@CuO material.

### Embodiment 21

According to this embodiment, a preparation method of spindle-shaped W@CuO material comprises the following steps:
adding 9.0 mmol sodium bis(2-ethylhexyl)succinate sulfonate (4.0010 g) to 100 mL n-butanol, and processing ultrasonication until clear to obtain M1 solution;
adding 0.45 mmol copper acetate (0.0898 g) to 300 mL deionized water, and processing ultrasonication until clear to obtain M2 solution;
adding 0.075 mmol sodium tungstate (0.0247 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 48 mmol ammonia water (0.8 mL) at a rate of one drop per five seconds; stirring for 2 hours and then carrying out hydrothermal reaction at 120° C. for 5 hours; then carrying out centrifugation, washing and drying to obtain a spindle-shaped W@CuO material.

### Embodiment 22

According to this embodiment, a preparation method of spindle-shaped W@CuO material comprises the following steps:
adding 9.0 mmol sodium bis(2-ethylhexyl)succinate sulfonate (4.0010 g) to 100 mL n-butanol, and processing ultrasonication until clear to obtain M1 solution;
adding 0.45 mmol copper acetate (0.0898 g) to 300 mL deionized water, and processing ultrasonication until clear to obtain M2 solution;
adding 0.075 mmol sodium tungstate (0.0247 g) to 50 mL deionized water and processing ultrasonication until clear to obtain M3 solution;
dripping the M2 solution to the M1 solution at a rate of one drop every two seconds to form a microemulsion; stirring for 1 hour and then adding the M3 solution at a rate of one drop per second; stirring for 2 hours and then adding 72 mmol ammonia water (1.2 mL) at a rate of one drop per five seconds; stirring for 2 hours and then carrying out hydrothermal reaction at 120° C. for 36 hours; then carrying out centrifugation, washing and drying to obtain a spindle-shaped W@CuO material.

### Exemplary Effect of Embodiment

According to the production method of the working electrode, the W@CuO materials prepared from embodiment 1, embodiment 5 and embodiment 9 are used as the working electrodes for electrochemical testing. The testing results show that: the W@CuO materials prepared from embodiment 1 has an overpotential of 95 mV only at a current density of 10 mA·cm⁻², and a corresponding Tafel slope of 67 mV·dec⁻¹ in a 1 mol·L⁻¹ KOH electrolyte; and that after working for 120 hours with an initial operating current density of 20 mA·cm⁻², the current density drops to 17.1 mA·cm⁻², with a retention rate of 85.5%; after working for 50 hours with an initial operating current density of 100 mA·cm⁻², the current density drops to 82.1 mA·cm⁻², with a retention rate of 82.1%,

The above descriptions are merely the preferred embodiments of the present invention and are not intended to be limiting. Any modifications, equivalent substitutions, improvements, etc. made within the spirit and principles of the present invention shall be included within the scope of protection of the present invention.

1: A preparation method of spindle-shaped W@CuO material with adjustable included angle, characterized in that, comprising the following steps:
(1) adding anionic surfactant to n-butanol, and processing ultrasonication until clear to obtain M1 solution;
(2) adding copper source and tungsten source to deionized water respectively, and processing ultrasonication until clear to obtain M2 solution and M3 solution respectively;
(3) dripping the M2 solution in step (2) to the M1 solution in step (1) to obtain a microemulsion;
(4) stirring and then dripping the microemulsion in step (3) into the M3 solution in step (2), stirring again and dripping an alkali solution, carrying out hydrothermal reaction, centrifugation, washing and drying to obtain a spindle-shaped W@CuO material with adjustable angle.

2: The preparation method of spindle-shaped W@CuO material with adjustable included angle according to claim 1, characterized in that, in step (1), the anionic surfactant is sodium bis(2-ethylhexyl)succinate sulfonate, sodium lauryl sulfate or ammonium lauryl sulfate; and a concentration of the anionic surfactant in the M1 solution is 30-100 mmol/L.

3: The preparation method of spindle-shaped W@CuO material with adjustable included angle according to claim 2, characterized in that, in step (2), the copper source is any one of copper acetate, copper chloride, copper sulfate and copper nitrate; the tungsten source is any one of sodium tungstate, ammonium metatungstate and ammonium paratungstate.

4: The preparation method of spindle-shaped W@CuO material with adjustable included angle according to claim 3, characterized in that, a concentration of the copper source in the M2 solution is 0.5-2 mmol/L; and a concentration of the tungsten source in the M3 solution is 0.5-2 mmol/L.

5: The preparation method of spindle-shaped W@CuO material with adjustable included angle according to claim 4, characterized in that, in step (3), a volume ratio of M1 solution and M2 solution is 1:3.

6: The preparation method of spindle-shaped W@CuO material with adjustable included angle according to claim 5, characterized in that, in step (4), the alkali solution is sodium hydroxide solution, potassium hydroxide solution or ammonia water; a molar ratio of the copper source, the tungsten source and the alkali in the hydrothermal reaction system is 1:0.01-0.2:100-400.

7: The preparation method of spindle-shaped W@CuO material with adjustable included angle according to claim 6, characterized in that, a temperature of the hydrothermal reaction is 25° C.-180° C., and a reaction time is 2 hours-72 hours.

8: The preparation method of spindle-shaped W@CuO material with adjustable included angle according to claim 4, characterized in that, the spindle-shaped W@CuO material has a spindle-shaped structure, and an included angle of the spindle-shaped structure is 27°-74°.

9: The spindle-shaped W@CuO material according to claim 8, has an application in electrolyzing water to produce green hydrogen.

10: The spindle-shaped W@CuO material according to claim 8, has an application in preparing alkaline water electrolysis hydrogen evolution catalyst.

11: The preparation method of spindle-shaped W@CuO material with adjustable included angle according to claim 5, characterized in that, the spindle-shaped W@CuO material has a spindle-shaped structure, and an included angle of the spindle-shaped structure is 27°-74°.

12: The preparation method of spindle-shaped W@CuO material with adjustable included angle according to claim 6, characterized in that, the spindle-shaped W@CuO material has a spindle-shaped structure, and an included angle of the spindle-shaped structure is 27°-74°.

13: The preparation method of spindle-shaped W@CuO material with adjustable included angle according to claim 7, characterized in that, the spindle-shaped W@CuO material has a spindle-shaped structure, and an included angle of the spindle-shaped structure is 27°-74°.

14: The spindle-shaped W@CuO material according to claim 11, has an application in electrolyzing water to produce green hydrogen.

15: The spindle-shaped W@CuO material according to claim 12, has an application in electrolyzing water to produce green hydrogen.

16: The spindle-shaped W@CuO material according to claim 13, has an application in electrolyzing water to produce green hydrogen.

17: The spindle-shaped W@CuO material according to claim 11, has an application in preparing alkaline water electrolysis hydrogen evolution catalyst.

18: The spindle-shaped W@CuO material according to claim 12, has an application in preparing alkaline water electrolysis hydrogen evolution catalyst.

19: The spindle-shaped W@CuO material according to claim 13, has an application in preparing alkaline water electrolysis hydrogen evolution catalyst.
